(19) United States
(12) Patent Application Publication
(10) Pub. No.: US 2015/0151454 A1
(43) Pub. Date: Jun. 4, 2015

(54) METHOD AND SYSTEM FOR RECYCLING UNCURED COMPOSITE OFFCUTS

(71) Applicant: Airbus Operations GmbH, Hamburg (DE)

(72) Inventors: Axel Herrmann, Stade (DE); Jens Walla, Hamburg (DE); Tassilo Witte, Stade (DE)

(21) Appl. No.: 14/551,759

(22) Filed: Nov. 24, 2014

(30) Foreign Application Priority Data
Nov. 28, 2013 (EP) 13 194 738.4

(51) Int. Cl. B29B 17/00; B29C 55/00; B29C 47/10; B29C 47/12; B29B 7/00; B29B 7/38

(52) U.S. Cl. CPC B29B 17/0042; B29B 7/002; B29B 7/38; B29C 47/1018; B29C 47/12; B29C 55/00; B29L 2031/3076

(57) ABSTRACT

A method of recycling scraps or offcuts of uncured composite material, such as pre-impregnated or “prepreg” scraps or offcuts having reinforcing fibres and uncured polymer matrix material, includes introducing the scraps or offcuts into a mixing device directly; mixing the scraps or offcuts in the mixing device to blend uncured polymer matrix material and reinforcing fibres of the scraps or offcuts into a generally homogenous or consistent mixture; and feeding or conveying the mixture from the mixing device into a shaping mechanism to form a component or semi-finished product and preferably on a continuous basis.

### CROSS-REFERENCE TO RELATED APPLICATION

This application claims priority to European Patent Application No. 13 194 738.4 filed Nov. 28, 2013, the entire disclosure of which is incorporated by reference herein.

### TECHNICAL FIELD

The present disclosure relates to a method and a system for recycling scraps or offcuts of uncured composite material, especially pre-impregnated or “prepreg” fibre reinforcement having uncured polymer (resin) matrix material.

### BACKGROUND

The use of composite materials in the design and manufacture of aircraft and spacecraft is becoming increasingly prevalent due to the low-weight and relatively high-strength properties achievable with those materials, among which fibre-reinforced polymer composites, such as carbon fibre reinforced polymers (CFRP), are especially preferred. As fibre-reinforced polymer composite materials now find increasing application in modern aircraft and spacecraft production, the amount of composite materials remaining as scrap after these production processes is also increasing. Much of that scrap is simply disposed of as waste, leading to a significant loss of a high-value and high-cost material. The method and system of the disclosure are therefore directed to redressing this loss and are especially suitable for use in the aircraft and aerospace industries. It will be appreciated, however, that the method and system of the disclosure are not limited to the aircraft and aerospace industries, but may be used in a wide range of applications where fibre-reinforced polymer composites are employed.

Currently, to salvage reinforcing fibres in scraps or offcuts of prepreg CFRP composite sheet, the polymer matrix material is removed, for example via pyrolysis. In addition to being energy and time intensive, however, this results in the loss of the intrinsic value in the polymer matrix material. Other recycling processes for composite scraps or offcuts involve grinding or milling the scrap into particulate. However, this not only involves a pre-processing or pre-treatment of the scrap material, but also results in a complete loss of the reinforcing fibre length.

### SUMMARY

It is therefore one idea of the present disclosure to provide a new and improved method and system for overcoming one or more of the problems discussed above. In particular, it would be useful to provide a new and improved method of recycling scraps or offcuts of uncured composite material, such as pre-impregnated or prepreg fibre reinforcement scraps or offcuts. In this way, secondary parts or components may be produced to lower production costs, the buy-to-fly ratio of components in the material acquisition chain can be improved; and overall ecology of production in fibre-reinforced polymer composites, such as CFRP, can be enhanced.

According to one aspect, therefore, the disclosure provides a method of recycling scraps or offcuts of uncured composite material, such as pre-impregnated or prepreg scraps or off-cuts comprising reinforcing fibres and uncured polymer matrix material, the method comprising:
introducing the scraps or offcuts into a mixing device directly;
mixing the scraps or offcuts in the mixing device to blend the uncured polymer matrix material and the reinforcing fibres of the scraps or offcuts into a generally homogenous or uniform mixture; and
feeding or conveying the mixture from the mixing device, preferably into a shaping mechanism to form a component or a semi-finished product.

An advantage of the above method is that the scraps or off-cuts of the uncured composite material can be introduced into the mixing device directly. That is, no pre-treatment of the scraps or offcuts is required. They may, of course, be stored temporarily before they are processed in the mixing device in order to ensure that a sufficient amount of those scraps or offcuts have been collected to sustain or support a recycling procedure according to this disclosure. In the mixing device the uncured polymer matrix material and reinforcing fibres from the scraps or offcuts are worked and blended together to a substantially consistent mass, which is then suitable for shaping to a new product. In this way, the previous waste of the scraps or offcuts can be readily recycled and used in other components, e.g. extruded profile elements like gusset fillers, which may not demand a high load-bearing capacity or role but can nevertheless be important elements in assembly of the overall structure.

In an embodiment, the method is configured to form a continuous component or semi-finished product. In other words the step of feeding or conveying the mixture from the mixing device into a shaping mechanism to form a component or semi-product desirably proceeds on a continuous basis and the component produced is preferably elongate and/or continuous, e.g. having a generally constant cross-sectional shape or profile. An example of such a component is a gusset filler.

In another embodiment, the shaping mechanism includes an extrusion die. The mixture generated by the mixing device should therefore be a sufficiently soft and flexible mass for it to be extruded through the die. As such, the feeding step preferably includes extrusion or “pultrusion” of the mixture through the extrusion die.

In another embodiment, the shaping mechanism includes one or more forming rollers configured to engage and/or to press sides of the mixture fed or conveyed from the mixing device to form a desired or predetermined cross-section or profile of the component.

In another embodiment, the shaping mechanism may include a molding tool. The molding tool preferably has a plurality of mold parts and is configured to clamp or press, and thus also hold, the mixture therein or there-between. As such, the feeding step may preferably include feeding or drawing the mixture into the molding tool, whereby the molding tool is configured to draw the mixture from the mixing device. Thus, the mold parts of the molding tool are typically movable between an open position for receiving the mixture as it is fed or conveyed from the mixing device and a closed position for pressing or shaping the mixture. Further, the molding tool is preferably movable to draw or pull the mixture from an outlet of the mixing device. In this way, the molding tool may form at least part of the feed mechanism.

In another embodiment, the mixing includes kneading, stirring, blending, and/or otherwise working the scraps or offcuts of uncured composite material in the mixing device. In this regard, the mixing step may include some shearing or milling of the reinforcing fibres as the scraps or offcuts are worked to form the generally homogenous or consistent mixture, but the amount of shearing or cutting is desirably small in order to ensure that the reinforcing fibres retain some of their length. For example, the fibres of the scraps or offcuts may have a length in the range of about 100 mm to about 200 mm and, after mixing, the fibres of the mixture may have a length of about 10 mm to about 20 mm. To this end, the mixing device preferably includes at least one agitator member arranged in a mixing chamber for kneading, stirring, blending, and/or otherwise working the scraps or offcuts. In another embodiment, mixing the scraps or off-cuts in the mixing device includes introducing or supplying additional polymer matrix material into the mixing device.

In another embodiment, the method further comprises curing the component or semi-finished product formed by the shaping mechanism. The curing step will typically finish or harden the component into a product that has its final shape or form. In this regard, the curing step is preferably carried out in the molding tool and at a temperature in the range of about 60° C. to about 200° C., for example in the range of about 80° C. to 180° C., and for example in the range of about 100° C. to 160° C., e.g. at about 150° C.

To this end, the polymer matrix material is typically a polymer resin, such as a thermosetting resin, and may be selected from the group consisting of epoxy, polyester, vinyl ester, and nylon resins. As already noted above, the scraps or offcuts are preferably uncured prepreg of fibre reinforced polymer sheet material, such as carbon fibre reinforced polymer (CFRP), glass fibre reinforced polymer (GFRP), and/or aramid fibre reinforced polymer (AFRP). Alternatively, or in addition, the scraps or offcuts may comprise sheet molding compound (SMC).

In another embodiment of the disclosure, the method comprises one or more of:
collecting the uncured scraps or offcuts;
sorting the uncured scraps or offcuts according to a type and/or grade of the reinforcing fibres or of the uncured polymer matrix material; and
storing the collected uncured scraps or offcuts in a cooled or refrigerated environment to minimise loss of the polymer matrix material.

In another embodiment, the method further comprises applying a film layer to at least one side of the mixture fed from the mixing device. In this way, each film layer preferably forms a release film which assists removal of the component or product from the molding tool.

According to a simplified aspect of the present disclosure, it will be noted that the method of recycling scraps or offcuts of uncured composite material may defer the step of feeding or conveying the mixture into a shaping mechanism. In other words, the method may just comprise: introducing the scraps or offcuts directly into a mixing device; mixing the scraps or offcuts in the mixing device to blend the uncured polymer matrix material and the reinforcing fibres of the scraps or offcuts into a generally homogenous or uniform mixture; and feeding or conveying the mixture from the mixing device as a semi-finished product. In this way, the mixed semi-finished product may be stored for shaping or forming in a subsequent or later procedure.

According to another aspect, the present disclosure provides a system for recycling scraps or offcuts of uncured composite material, such as pre-impregnated or prepreg reinforcement fibres with uncured polymer matrix material, comprising:
a mixing device including: an inlet configured for introducing the scraps or offcuts into the mixing device, a mixing chamber configured for mixing the uncured polymer matrix material and reinforcement fibres of the scraps or offcuts to provide a generally homogenous or consistent mixture, and an outlet configured for discharging the mixture from the mixing device;
a feed mechanism or a conveying mechanism for feeding or conveying the mixture from the mixing device; and
a shaping mechanism for forming the mixture into a component or product, wherein the shaping mechanism includes at least one of an extrusion die, a forming roller, and a molding tool.

In another embodiment, the mixing device includes at least one agitator member arranged in the mixing chamber and having a shape or profile configured to promote mixing of the polymer matrix material and reinforcement fibres. Preferably, the agitator member is movable and configured to mix, stir, knead, blend, and/or otherwise work the scraps or offcuts as it moves. In this regard, the agitator member is preferably configured to rotate and includes one or more mixing elements thereon for working the scraps or offcuts. In a particularly preferred embodiment, the at least one agitator member may be configured to convey or advance the mixture through the mixing device such that the agitator member forms at least part of the feed mechanism.

In another embodiment, the molding tool may be movable between an open position for receiving the mixture as it is fed or conveyed from the mixing device and a closed position for shaping the mixture. In this regard, the molding tool may have a plurality of mold parts configured to clamp or press the mixture between them in the closed position to form the component or product. Furthermore, the molding tool is desirably movable to draw or pull the mixture from the outlet of the mixing device, such that the molding tool may form at least part of the feed mechanism.

In another embodiment, the system further comprises a film applicator device configured to apply a film layer from a film roll to at least one side of the mixture as it is fed or conveyed from the mixing device. As noted above, each film layer may therefore form a release film to assist removal of the component or product from the molding tool.

According to a further aspect, the present disclosure provides a component that is produced or fabricated by a method and/or system of the present disclosure according to any one of the embodiments described above. In another aspect, the disclosure also provides a vehicle, such as an aircraft or spacecraft, with an airframe or fuselage structure including at least one component, for example several components, produced or fabricated by a method and/or system of the disclosure according to any of the embodiments described above.

### BRIEF DESCRIPTION OF THE DRAWINGS

For a more complete understanding of the present disclosure and the advantages thereof, exemplary embodiments of the disclosure are explained in more detail in the following description with reference to the accompanying drawings, in which like reference characters designate like parts and in which:

FIG. 1 is a schematic cross-sectional side view of a system for recycling scraps or offcuts of uncured composite material according to an embodiment of the disclosure, with detail of an extrusion die and a molding tool;

FIG. 2 is another cross-sectional side view of the system of FIG. 1 showing introduction and mixing of the scraps or offcuts;

FIG. 3 is another cross-sectional side view of the system of FIG. 1 showing the mixture being extruded into the molding tool;

FIG. 4 is a further schematic cross-sectional side view of the system of FIG. 1 showing the mixture being clamped in a first molding tool;

FIG. 5 is yet another cross-sectional side view of the system of FIG. 1 showing the mixture drawn from the mixing device by a first molding tool and relative movement of a second molding tool;

FIG. 6 is another cross-sectional side view of the system of FIG. 1 showing reversed positions of the first and second molding tools;

FIG. 7 is another cross-sectional side view of the system of FIG. 1 showing a release of the first molding tool and clamping by the second molding tool;

FIG. 8 is another cross-sectional side view of the system of FIG. 1 showing the mixture drawn from the mixing device with the second molding tool and relative movement of the first molding tool;

FIG. 9 is another cross-sectional side view of the system of FIG. 1 showing the first and the second molding tools returning to their starting positions; and

FIG. 10 is a schematic illustration of an aircraft having a fuselage or airframe structure which includes one or more component produced by a method or a system according to an embodiment of the disclosure.

### DETAILED DESCRIPTION

The accompanying drawings are included to provide a further understanding of the present disclosure and are incorporated in and constitute a part of this specification. The drawings illustrate particular embodiments of the disclosure and together with the description serve to explain the principles of the disclosure. Other embodiments of the disclosure and many of the attendant advantages of the disclosure will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not necessarily required. It will also be understood that the terms and expressions used in the present specification have the ordinary meaning as is accorded to such terms and expressions with respect to their corresponding respective areas of inquiry and study, except where specific meanings have otherwise been set forth herein.

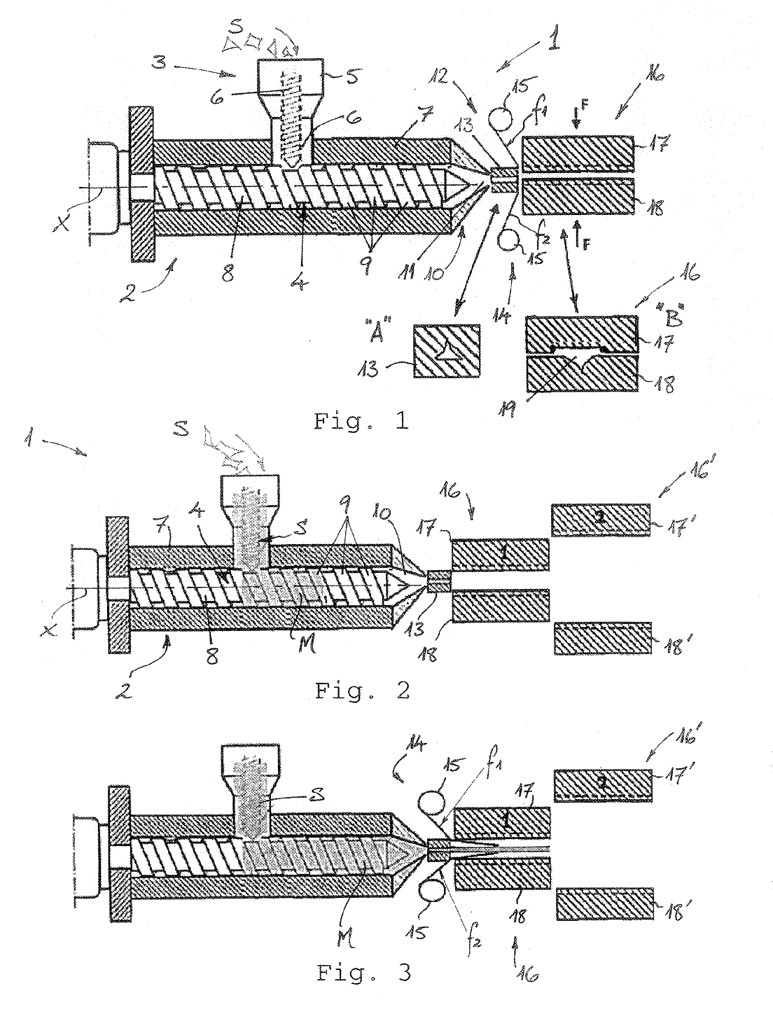

With reference firstly to FIG. 1 of the drawings, a system 1 for recycling scraps or offcuts S of uncured pre-impregnated (i.e. prepreg) CFRP sheets according to an embodiment of the disclosure is illustrated schematically in a cross-sectional side view. The system 1 includes a mixing device 2 having an inlet 3 which is configured for receiving and introducing the scraps or offcuts S into a mixing chamber 4 of the device 2. In particular, the inlet 3 includes a hopper or funnel-shaped channel 5 for receiving the scraps or offcuts S and a screw- or auger-type delivery member 6 for conveying the scraps or offcuts S from the inlet 3 into the mixing chamber 4. The mixing chamber 4 comprises a generally horizontally oriented cavity provided in a (e.g. cylindrical) housing 7 of mixing device 2. Extending centrally within the mixing chamber 4 and configured for rotation about its longitudinal axis X is an agitator member 8 having helical or screw-like elements 9 arranged along its length for engaging and working the scraps or offcuts S of the uncured composite material against the walls of the housing 7 of this mixing device 2. In this regard, the agitator member 8 is configured to stir, knead, blend and/or mix the uncured resin matrix material and the fibres from the prepreg scraps or offcuts S to a generally consistent or uniform mass or mixture M which may then be further processed.

By virtue of the helical or screw-like shape of the mixing elements 9 provided on the agitator member 8, the agitator member not only works the scraps or offcuts S but also acts to advance or convey the mixture M of resin matrix and fibres generated from the scraps or offcuts S in the longitudinal or axial direction along a length of the mixing cavity 4 towards an outlet 10 of the mixing device 2. In this embodiment, the outlet 10 tapers conically to an outlet opening 11 which then delivers the mixture M to a shaping mechanism 12. That is, the outlet opening 11 communicates directly with an extrusion die 13, a transverse cross-section of which is illustrated in FIG. 1 as detail “A”. Because the agitator member 8 acts as a screw feed mechanism, the rotation of the agitator 8 forces the mass or mixture M of resin matrix and reinforcing fibres through the outlet 10 of the mixing device 2 into and through the extrusion die 13, which comprises a part of the shaping mechanism 12 for forming the mixture or mass M emerging from the mixing device 2.

Located downstream of the extrusion die 13, a film applicator device 14 is provided comprising rolls 15 of a polymer film or membrane f₁, f₂. This applicator device 14 is configured for applying a layer of the film f₁, f₂ to respective upper and lower sides of the mixture or mass M extruded through the die 13. As will be understood by persons skilled in the art, the film layers f₁, f₂ act as release films to prevent the composite mass or mixture M generated by the mixing device 2 from adhering to a molding tool 16 later in the procedure.

Completing the description of the system 1 shown in FIG. 1 of the drawings, the molding tool 16 can be seen in the path of the mixture M after it emerges from the extrusion die 13. In particular, the molding tool 16 comprises upper and lower mold parts 17, 18 which are movable between an open position for receiving the mixture M fed or conveyed from the mixing device 2 and a closed position, in which the mixture M is clamped and/or pressed between the mold parts 17, 18 to form a desired shape defined by a cavity 19 in the mold 16. In this example, the upper and lower mold parts 17, 18 are also shown in longitudinal cross-section in detail “B” of FIG. 1.

With consecutive reference now to drawing FIGS. 2 to 9, the manner in which the system 1 of the above embodiment operates and, therefore, the method according to an embodiment of this disclosure, will be explained in more detail.

As a preliminary step in the method of this disclosure, it will be noted that uncured fibre-reinforced polymer (FRP) prepreg scraps or offcuts S may be collected from various production processes or stations and sorted according to, for example, the type of reinforcing fibres (e.g. carbon fibres or aramid fibres) and/or the grade or quality of those fibres (e.g. fibre diameter and/or fibre orientation), as well as according to the particular resin matrix material involved. Of course, where predominantly only a single type of prepreg composite material is in use in the production processes, the sorting procedure may be limited to the size of the scraps or offcuts S. The method may also include the preliminary step of temporarily storing the collected scraps or offcuts S before the recycling procedure in the mixing device 2 begins. In this regard, the uncured prepreg scraps or offcuts S are desirably stored in a cooled or refrigerated environment to ensure that the resin matrix material remains firmly intact and retained to the fibre reinforcement.

As seen in FIG. 2, the scraps or offcuts S to be recycled are fed directly into the funnel-shaped hopper or channel 5 at an upper end of the inlet 3 to the mixing device 2. Introduction of the scraps or offcuts S into the mixing device 2 in this way typically takes place at room temperature (e.g. 20° C.), so that the uncured resin matrix may be workable as a relatively soft and flexible mass. Thus, referring to FIG. 2, the scraps or offcuts S are delivered into the mixing chamber 4 via the augur or screw delivery mechanism 6 in the inlet 3 and the reinforcing fibres and the mass of resin matrix material are kneaded, blended and mixed via helical or screw elements 9 of the agitator member 8 rotating about its longitudinal axis X.

One distinction between the illustration of the system 1 in this embodiment of drawing FIG. 2 and the system 1 described with reference to FIG. 1 is that FIG. 2 shows two molding tools 16, 16′, respectively labelled “1” and “2”. In other words, the system 1 in fact includes a first molding tool 16 with upper and lower mold parts 17, 18 and a second molding tool 16′ having upper and lower mold parts 17′, 18′. In this regard, however, the configuration of the mold cavity 19, 19 in each of the first and second molding tools 16, 16′ is substantially identical.

Referring now to FIG. 3, the mixed mass M of resin matrix and fibres is fed via the screw agitator 8 through the outlet 10 of the mixing device 2 and through the extrusion die 13 between the upper and lower mold parts 17, 18 of the first molding tool 16. At this stage, also, the upper film f₁ and the lower film f₂ are fed from the respective rolls 15 of the film applicator device 14 to cover the upper and lower sides or surfaces of the mixture M between the mold parts 17, 18 of the first molding tool 16.

Drawing FIG. 4 illustrates that the first molding tool 16 is moved to a closed position by applying a force F to the upper and lower mold parts 17, 18 such that the extruded mixture M fed or conveyed from the outlet 10 of the mixing device 2 is clamped and pressed between the mold parts 17, 18 in the mold cavity 19.

As can be seen in FIG. 5, the first molding tool 16 is then movable in the axial direction away from the mixing device 2 such that the first molding tool 16 acts to assist in the feeding or conveying of the mixture M from the mixing device 2. In particular, the movement of the first molding tool 16 in the axial direction draws or pulls the mass or mixture M from the extrusion die 13, which supports the feeding of that mixture M through the extrusion die 13 by the rotation of the screw-like agitator member 8. Accordingly, in this embodiment the mixture M undergoes a “pultrusion” procedure. As can also be seen in FIG. 5, as the first molding tool 16 is moved in the axial direction away from the mixing device 2, the second molding tool 16′ is moved with its upper and lower mold parts 17′, 18′ opened and separated from one another towards the mixing device 2.

Referring now to FIG. 6 of the drawings, the first molding tool 16 reaches a maximum position or displacement away from the mixing device 2 and the second molding tool 16′ reaches its maximum position towards the mixing device 2. As the first molding tool 16 moves with a section of the mixture M clamped within its mold cavity 19, the molding tool 16 may apply heat (and pressure) to the composite mixture M pressed between the mold parts 17, 18 to at least partially cure the polymer resin in the mixture M.

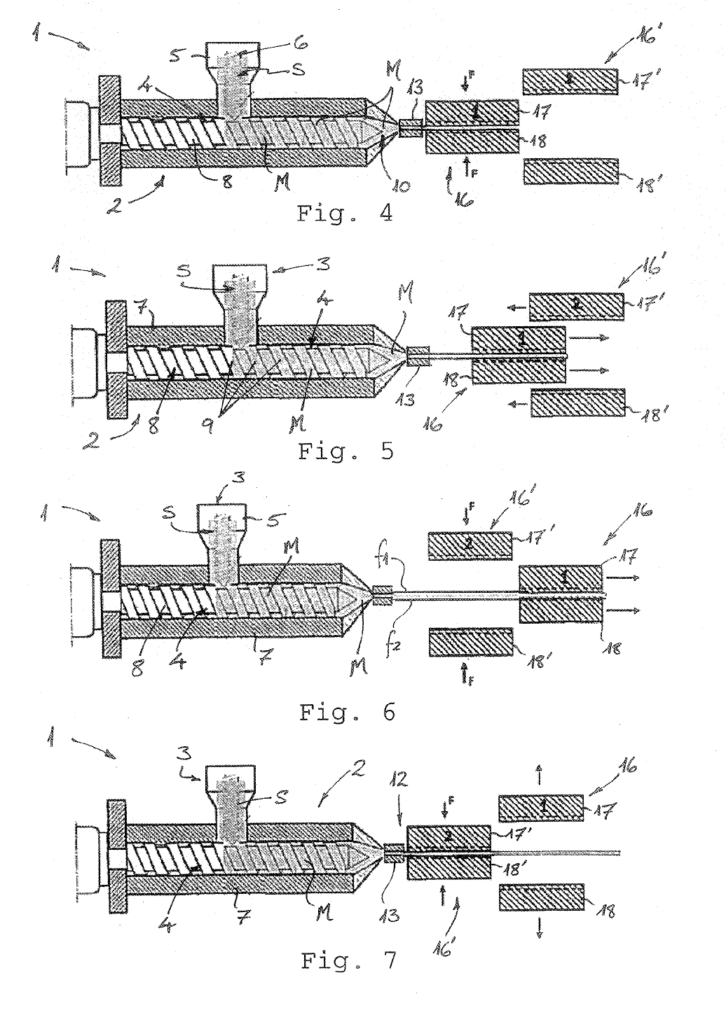

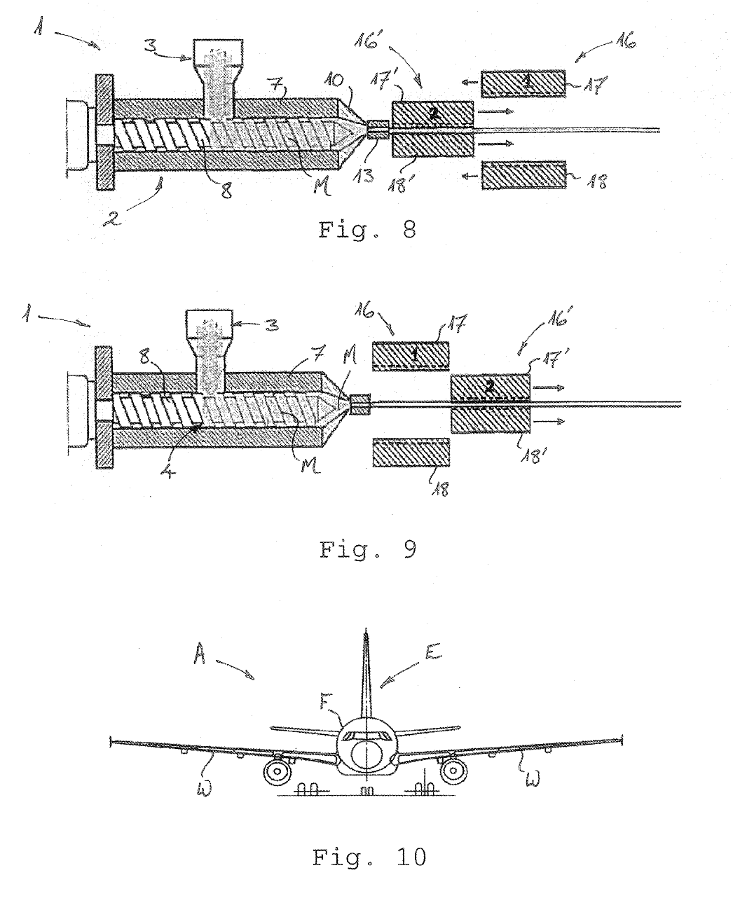

In FIG. 7 then, the upper and lower mold parts 17′, 18′ of the second molding tool 16′ are moved together to clamp and press the extruded mixture M of resin matrix and reinforcing fibres between them, while upper and lower mold parts 17, 18 of the first molding tool 16 are moved apart to an open position to release a completed section of the elongate and continuous component (e.g. gusset filler) therein.

Referring now to FIG. 8, the upper and lower mold parts 17, 18 of first molding tool 16 then move in the axial direction back towards the mixing device 2 while the closed and clamped second molding tool 16′ moves in the axial direction away from the mixing device 2 to draw and further support the feed or conveyance of the mass or mixture M of resin matrix and reinforcing fibres through extrusion die 13 on a continuous basis. Like the first molding tool 16, the second molding tool 16′ applies heat and pressure to the composite material pressed between the mold parts 17′, 18′ to perform curing as the second molding tool is moved in the axial direction away from the mixing device 2.

After the position of the first and second molding tools 16, 16′ in FIG. 9 is reached, respective upper and lower mold parts 17, 18, 17′, 18′ of the first and second molding tools 16, 16′ effectively return to their positions shown in FIG. 3 and the sequence of the method steps or operating procedure between FIG. 3 and FIG. 9 are repeated.

In this way, continuous production of a continuous component, namely a gusset filler, can be performed with the recycled composite material from the prepreg scraps or offcuts S with this system 1.

Finally, with reference to FIG. 10, a schematic illustration of an aircraft A is shown having an airframe which includes a fuselage F, wings W, and an empennage E. The airframe of the aircraft A incorporates one or more panel component formed by a system 1 and/or a method according to an embodiment of the disclosure, for example, as described above with reference to FIG. 1 to FIG. 9.

Although specific embodiments of the disclosure have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In this document, the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. A method of recycling scraps or offcuts of uncured composite material, such as pre-impregnated or prepreg scraps or offcuts having reinforcing fibres and uncured polymer matrix material, comprising:
introducing the scraps or offcuts into a mixing device directly;
mixing the scraps or offcuts in the mixing device to blend uncured polymer matrix material and reinforcing fibres of the scraps or offcuts into a generally homogenous or consistent mixture; and
feeding or conveying the mixture from the mixing device into a shaping mechanism to form a component or semi-finished product.

2. The method according to claim 1, wherein the shaping mechanism comprises: an extrusion die and the feeding step includes extruding or pultruding the mixture through the extrusion die, and/or one or more forming rollers which engage or press sides of the mixture to form a cross-section or profile of the component or semi-finished product.

3. The method according to claim 1, wherein the shaping mechanism includes a molding tool and wherein the feeding step includes feeding or drawing the mixture into the molding tool, wherein the molding tool is configured to clamp or to press and hold the mixture therein and to draw the mixture from the mixing device.

4. The method according to claim 1, wherein mixing the scraps or offcuts in the mixing device includes at least some partial shearing or milling of the reinforcing fibres to form the generally homogenous or consistent mixture.

5. The method according to claim 1, wherein mixing the scraps or offcuts in the mixing device includes supplying additional polymer matrix material into the mixing device.

6. The method according to claim 1, comprising one or more of:
collecting the uncured scraps or offcuts;
sorting the uncured scraps or offcuts according to a type and/or grade of the reinforcing fibres or the uncured polymer matrix material; and
storing the collected uncured scraps or offcuts in a cooled or refrigerated environment to minimise loss of the polymer matrix material.

7. The method according to claim 1, further comprising curing the component or semi-finished product formed by the shaping mechanism, wherein the curing occurs in the molding tool.

8. The method of claim 7, wherein curing the component or semi-finished product formed by the shaping mechanism occurs at a temperature in the range of about 60° C. to 200° C.

9. The method of claim 8, wherein curing the component or semi-finished product formed by the shaping mechanism occurs at a temperature in the range of 80° C. to 180° C.

10. The method of claim 9, wherein curing the component or semi-finished product formed by the shaping mechanism occurs at a temperature in the range of 100° C. to 160° C.

11. The method according to claim 1, further comprising applying a film layer to at least one side of the mixture fed from the mixing device, wherein each film layer forms a release film to assist removal of semi-finished products from the molding tool.

12. A system for recycling scraps or offcuts of an uncured composite material, such as reinforcement fibres pre-impregnated with uncured polymer matrix material, comprising:
a mixing device having: an inlet configured for introducing the scraps or offcuts into the mixing device, a mixing chamber configured for mixing reinforcement fibres and uncured polymer matrix material of the scraps or offcuts to produce a generally homogenous or consistent mixture, and an outlet configured for discharging the mixture from the mixing device;
a feed mechanism for conveying the mixture or mass from the mixing device; and
a shaping mechanism for forming the mixture into a component or product, wherein the shaping mechanism includes one or more of an extrusion die, a forming roller, and a molding tool.

13. The system according to claim 12, wherein the mixing device includes at least one movable mixing member arranged in the mixing chamber and having a profile configured to promote mixing of the reinforcement fibres and polymer matrix material as it moves, wherein the mixing member is preferably configured to rotate and includes one or more mixing elements thereon.

14. The system according to claim 12, wherein the at least one mixing member is configured to convey or advance the mixture through the mixing device such that the mixing member forms at least part of the feed mechanism.

15. The system according to claim 12, wherein the molding tool is movable between an open position for receiving the mixture and a closed position for shaping the mixture, wherein the molding tool is movable to draw or pull the mixture from the outlet of the mixing device, whereby the molding tool forms at least part of the feed mechanism.

16. The system according to claim 12, further comprising a film applicator device configured to apply a film layer from a film roll to at least one side of the mixture fed or conveyed from the mixing device, wherein each film layer forms a release film to assist removal of the component or product from the molding tool.

17. The system according to claim 12, wherein the molding tool comprises a plurality of mold parts that clamp or press the mixture between them to form the component or product.

18. In an aircraft having an airframe or fuselage structure comprising one or more components fabricated a method of recycling scraps or offcuts of uncured composite material comprising pre-impregnated or prepreg scraps or offcuts having reinforcing fibres and uncured polymer matrix material, the method comprising:
introducing the scraps or offcuts into a mixing device directly;
mixing the scraps or offcuts in the mixing device to blend uncured polymer matrix material and reinforcing fibres of the scraps or offcuts into a generally homogenous or consistent mixture; and
feeding or conveying the mixture from the mixing device into a shaping mechanism to form a component or semi-finished product.
